(19) United States
(12) Patent Application Publication
(10) Pub. No.: US 2026/0134476 A1
(43) Pub. Date: May 14, 2026

(54) Blockchain-Based Web3 Subdomain System for Tokenization, Certification, and Income Management of Real-World, Digital, and Identity Assets

(71) Applicant: Matthew Smith Shepley, Nebo, NC (US)

(72) Inventor: Matthew Smith Shepley, Nebo, NC (US)

(21) Appl. No.: 18/947,906

(22) Filed: Nov. 14, 2024

(51) Int. Cl. G06Q 40/06; G06F 16/955; G06F 40/295; G06Q 20/10; G06V 30/10

(52) U.S. Cl. CPC G06Q 40/06; G06F 16/9554; G06F 40/295; G06Q 20/10; G06V 30/10; G06Q 2220/00

(57) ABSTRACT

The invention presents a blockchain-based system for the tokenization, certification, and management of real-world assets, digital assets, and verified identities. It integrates Web3 domain-subdomain tokens, distributed ledger technology (DLT), decentralized identifiers (DIDs), and AI-driven verification processes to provide secure and transparent transactions. The system employs KYC subdomain tokens linked to users' blockchain wallets for identity verification, enabling compliance with regulatory standards. Human-readable Web3 tokens enhance asset traceability. AI and manual verification ensure efficient and accurate processing. Scalable and flexible, the system supports diverse asset types and includes time-based voiding mechanisms to address incomplete transactions, ensuring effective lifecycle management.

### FIELD OF THE INVENTION

The present invention generally relates to the field of digital certification and tokenization of real-world, digital, and identity assets.

### BACKGROUND OF THE INVENTION

Current methods for managing, certifying, and transferring ownership of real-world assets such as land titles, vehicles, commodities, and artwork are often fragmented and rely heavily on manual processes. These methods are prone to human error, are time-consuming, and frequently lack adequate security measures to prevent tampering or fraud.

Current methods for managing digital assets, such as data, intellectual property, and verified identity, face similar challenges, including a lack of secure, portable, and verifiable representations. Additionally, identity verification remains a fragmented process, often relying on centralized databases vulnerable to breaches and unauthorized access.

Centralized databases, which are commonly used to store ownership records, are vulnerable to unauthorized access, data manipulation, and single points of failure, leading to potential disputes and challenges in asset ownership verification.

Despite advances in blockchain technology, current systems lack a comprehensive framework for tokenizing a broad range of asset types, including identity, digital property, and real-world assets, and fail to address incomplete transactions effectively.

With the rapid growth of digital asset markets and increasing regulatory scrutiny, there is a heightened demand for a secure, automated system that can effectively manage the tokenization, certification, and transaction processes across a diverse range of assets.

Existing systems do not include a mechanism to automatically void smart contracts (self-executing contracts with terms written in code, running on a blockchain, which automatically enforces and executes the agreed-upon conditions) if certification is not completed within a predefined timeframe, which can lead to stalled transactions or unverified agreements.

Blockchain technology has emerged as a powerful tool for ensuring transparency and security in transactions, offering a decentralized approach to recording and managing ownership rights. However, existing systems are often limited in scope, focusing on specific asset classes or lacking integration with modern technologies such as Web3 domains, decentralized identifiers (DIDs) for identity, and artificial intelligence (AI).

For instance, U.S. 2021/0090189 focuses on using blockchain for land title management, while U.S. 2019/0080392 addresses the tokenization of commodity assets. These systems do not offer a comprehensive solution that integrates Web3, Distributed Ledger Technology (DLT), and Artificial Intelligence (AI) to manage a broad range of real-world assets.

In the evolving landscape of digital asset management, there is an urgent need for a comprehensive, secure, and automated system that can ensure the immutability of smart contracts once they have been verified. Current solutions fail to integrate advanced technologies such as Web3, DLT, and AI. This lack of integration leads to significant vulnerabilities and inefficiencies when managing real-world assets like real estate, vehicles, artwork, and commodities. As a result, current systems are prone to fraud, manual errors, and unauthorized modifications that undermine trust in the system. Additionally, existing solutions often lack scalability, making them ill-suited for managing the complex requirements of diverse asset types and high transaction volumes.

### SUMMARY OF THE INVENTION

One embodiment of the present invention may comprise a method for tokenizing and managing assets using blockchain technology. The method comprises causing a domain-subdomain token to be created, the token having a top-level domain identifier, and one or more subdomain identifiers under the top level domain, at least one of the sub-domain identifiers associated with an asset. The method also comprises causing a smart contract to be generated on a blockchain in relation to the asset, wherein the smart contract references the domain-subdomain token.

In some embodiments, the domain-subdomain token comprises exactly one subdomain identifier. In some embodiments, the domain-subdomain token comprises exactly two subdomain identifiers. In some embodiments, the method also includes using the domain-subdomain token in a blockchain name service query to obtain an address for a smart contract associated with the asset.

In some embodiments, the method further comprises creating underlying data for a quick response (QR) code, the data having a uniform resource locator (URL), and the URL having the domain-subdomain token therein. The method may also include providing access to a webpage corresponding to the URL of the QR code.

In some embodiments, the smart contract comprises an income distribution schedule in the smart contract, wherein funds are automatically distributed by the smart contract to token holders based at least in part on ownership percentage.

In another embodiment, there is a method for tokenizing and managing real-world assets using blockchain technology. The method comprises initiating a tokenization process for an asset by staging asset parameters in a database before generating a smart contract on a distributed blockchain, the smart contract being associated with the asset. The method also comprises verifying the asset's ownership and existence by comparing asset parameters against information obtained from one or more digital documents. The method also comprises causing a domain-subdomain token to be created after successful verification of the asset's ownership and existence, the token having a top level domain identifier, and one or more subdomain identifiers under the top level domain, at least one of the sub-domain identifiers associated with an asset. And the method also comprises causing to be generated a smart contract corresponding to the asset, wherein the smart contract references the domain-subdomain token.

In some embodiments, the method further comprises creating underlying data for a quick response (QR) code, the data having a uniform resource locator (URL), and the URL having the domain-subdomain token therein. The method may also include providing access to a webpage corresponding to the URL of the QR code.

In some embodiments, the smart contract is immutable. In some embodiments, the smart contract makes available asset tokens representing fractional or full ownership of the asset.

In some embodiments, the method may include receiving closing or ownership documents for certification, generating a certification domain-subdomain token, and sending the certification domain-subdomain token to the smart contract, wherein thereafter the smart contract releases funds to a wallet address.

In some embodiments, the method may include generating a closing domain-subdomain token after the sale or transfer of the asset, and sending the closing domain-subdomain token to the smart contract. In some embodiments, the smart contract releases funds to a wallet address upon receipt of a token from that wallet address.

In some embodiments, the method may also include receiving closing or ownership documents for certification, generating a voiding domain-subdomain token, and sending the voiding domain-subdomain token to the smart contract, wherein thereafter further transactions with the smart contract are prevented.

In some embodiments, the smart contract will become invalidated if a certification domain-subdomain token is not received by the smart contract within a predefined period of time. In some embodiments, at least a portion of the information obtained from one or more of the digital documents is obtained using optical character recognition and named entity recognition.

In some embodiments, the smart contract comprises a payment escrow so that the smart contract holds funds until receipt of a second domain-subdomain token.

In another embodiment, there is a method for tokenizing a know-your-customer (“KYC”) process on a blockchain. The method comprises generating KYC subdomain token information, the token information having a top level domain identifier, and one or more subdomain identifiers under the top level domain identifier, at least one of the subdomain identifiers corresponding to a specific person or entity. The method also comprises causing the KYC subdomain token information and wallet information to be sent to a blockchain name service whereafter the blockchain name service generates a KYC subdomain token comprising the KYC subdomain token information and the wallet information.

In some embodiments, the method may comprise creating underlying data for a quick response (QR) code, the data having a uniform resource locator (URL), and the URL having the KYC subdomain token therein. In some embodiments, the method may also include providing access to a webpage corresponding to the URL of the QR code.

In some embodiments, the method further comprises generating a smart contract on a blockchain, the smart contract configured to interact only with a blockchain wallet associated with a KYC subdomain token.

In some embodiments, the method also comprises causing a smart contract associated with the block chain name service to send a token comprising at least a portion of the KYC subdomain token information to the wallet address.

In some embodiments, the method may also comprise causing to be updated in the block chain name service the wallet address associated with the KYC subdomain token to a different wallet address.

### BRIEF DESCRIPTION OF THE DRAWINGS

FIG. 1 depicts a high-level system architecture diagram for an exemplary embodiment of the invention.

FIG. 2 depicts a first set of steps involved in an exemplary tokenization process.

FIG. 3 depicts a second set steps involved in an exemplary tokenization process.

FIG. 4 depicts an income transfer process for tokenized assets.

FIG. 5 depicts various embodiments of web3 domain-subdomain tokens.

FIG. 5A depicts various embodiments of web3 domain-subdomain tokens.

FIG. 6 depicts a high-level view of one embodiment of a tokenization process.

FIG. 7 depicts various steps of an exemplary embodiment of a web3 KYC tokenization process.

FIG. 8 depicts an exemplary embodiment of a web3 KYC subdomain token structure.

FIG. 9 depicts an exemplary embodiment of a web3 KYC subdomain token structure.

### DETAILED DESCRIPTION

Various embodiments of the present invention are described with reference to the attached figures herein. It should be understood that numerous specific details, relationships, and methods are set forth to provide an understanding of the invention. One skilled in the relevant art, however, will readily recognize that the invention can be practiced without one or more of the specific details or with other methods.

The present invention relates to a blockchain-based system for securely managing the tokenization, certification, and transaction processes of real-world assets, digital assets, and verified identities. By integrating Web3 domain-subdomain tokens, distributed ledger technology (DLT), and AI-driven verification processes, the system helps ensure the immutability of smart contracts, protects client funds, and facilitates transparent asset management. This combination of technologies provides a secure and automated framework that enhances the efficiency and accuracy of managing real-world assets, both tangible and intangible.

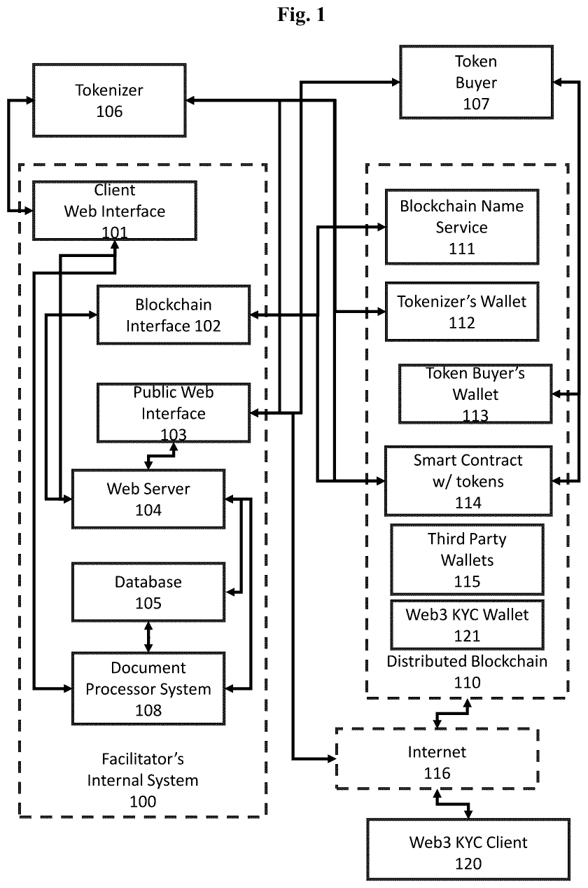

FIG. 1 depicts a high-level system architecture diagram providing an overview of some components involved in an exemplary blockchain-based tokenization, certification, and asset management process. Item 100 is a facilitator's internal system. The internal system has a client web interface 101, a blockchain interface 102, a public web interface 103, a web server 104, a database 105, and document processor system 108. Item 110 is a distributed blockchain. The distributed blockchain has a blockchain name service 111, a tokenizer's wallet 112, a token buyer's wallet 113, third party wallets 115, and a smart contract with tokens 114. Also shown is a tokenizer 106 and a token buyer 107. The assets may include physical and digital assets as well as identity verification. Also present in FIG. 1 is a Web3 know-your-customer (“KYC”) client 120 with a Web3 KYC blockchain wallet 121 associated therewith.

The public web interface may provide a website and various web services and/or an API for interacting with visitors seeking information from the facilitator's internal system, as well as provide an internal interface and/or an API for the Internet 116 so that systems like the document processor system 108 may gather data from websites and web related services on the Internet 116.

The facilitator's internal system may also have various security layers that help ensure that operations are protected. These layers may include encryption of sensitive data and multi-factor authentication (MFA) for access control, preventing unauthorized access and tampering.

The system may also employ advanced encryption protocols to ensure that document submissions and token generation are highly secure, maintaining data privacy throughout the certification process. Such encryption techniques safeguard sensitive information, preventing unauthorized access and ensuring the integrity of all data exchanges.

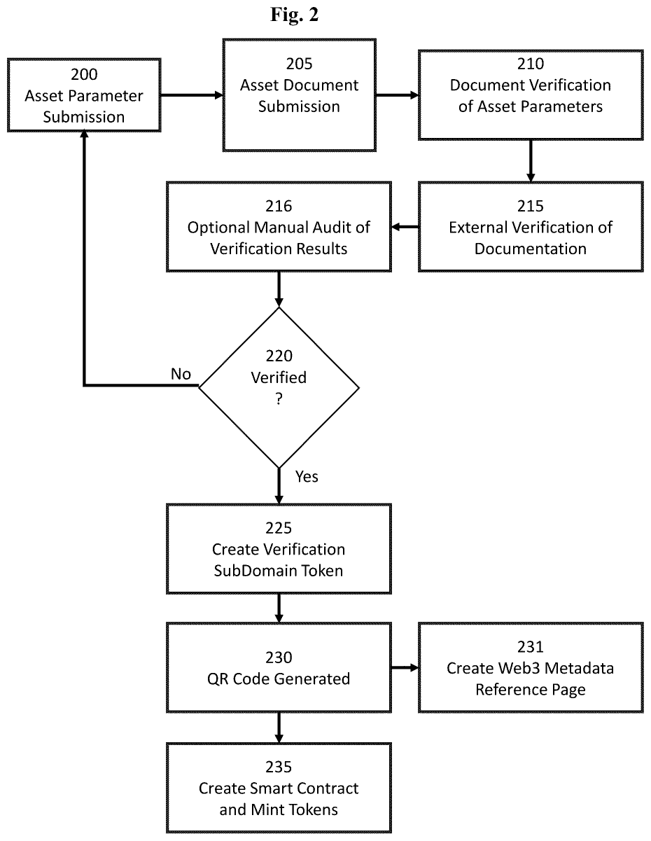

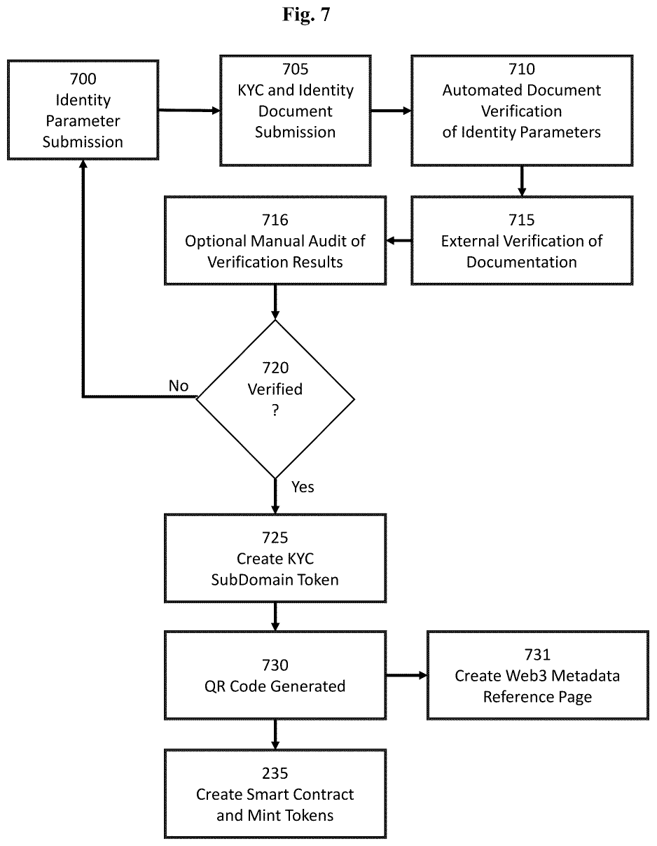

FIG. 2 depicts various steps involved in an exemplary tokenization process. (The related KYC verification process of FIG. 7 may also be run in parallel or in series with this process of FIG. 2.) In step 200, a tokenizer 106 enters asset parameters into a tokenization facilitator's 100 internal system via a secured web2 data collection interface (e.g., the client web interface 101) for storage in database 105. Exemplary asset parameters may include but are not limited to:
Asset Type
Asset Value
First Token Type
Second Token Type
Number of Tokens for Each Type
Cost Per Token
Tokenizer's Wallet Address
Certification Time Limit:
Identification of Asset Owner
Identification of Asset
Legal Documentation References

A unique asset ID for the asset (e.g., US0000000000.ASSET01) is also created and stored in the database 105. This ID is used to track the asset through subsequent processes and is later used in connection with the verification token.

In step 205, the tokenizer submits the appropriate transaction documents (e.g., asset ownership documents, identification documents, financial documents, contract documents, etc.).

In step 210, the facilitator's internal system performs document verification against the asset parameters. The facilitator's document processing system 108 utilizes Artificial intelligence (“AI”) and related technologies like Optical Character Recognition (OCR) to scan and digitize the documents uploaded by the Tokenizer to the extent needed for that document type. The facilitator's document processing system 108 then uses Natural Language Processing (NLP) and Named Entity Recognition (NER) to identify and extract details such as the owner's name, asset location, and serial numbers, and so forth. Extracted data is then cross-referenced by the document processing system 108 with the asset parameters provided by the Tokenizer to verify correctness and consistency. In some cases, this may be done manually.

In step 215, extracted data is compared against external authoritative databases (such as chain of title records at a county property website) to verify authenticity and ownership. This can be done via AI agents utilized by the document processing system 108 to gather web data, or through manual verification performed by humans. In some embodiments, both AI agents and manual verification are used. In a preferred embodiment, there is an optional manual audit 216 of AI generated verification results.

In step 220, if the verification process fails, then the tokenizer is notified of discrepancies and is invited to edit or resubmit the asset data and documentation whereafter the verification process is performed again. If the verification process is successful, then in step 225 the facilitator's internal system updates the asset status in the facilitator's internal system to “Verified,” and a subdomain ID token (e.g., US0000000000.ASSET01.XYZ) is generated. Note that the use of XYZ as a web3 top level domain label is arbitrary and exemplary herein. The domain label may or may not correspond to a web2 top level domain. Other top level domain labels may be used, for example, a company name, acronym, or trademark.

In step 230, in some embodiments, a binary quick reference (“QR”) code is generated by the facilitator's internal system upon asset verification. The QR code uses 0's and 1's (bits) to represent black and white pixels in a pixel frame, the bits create a scannable black and white QR code. The QR code is linked via a uniform resource locator (“URL”) to a web3 asset metadata reference page 231, created by facilitator and accessible through the public web interface 103, that incorporates the subdomain ID token (e.g., https://example.com/US0000000000.ASSET01.XYZ). When scanned, the QR code directs users to a webpage (e.g., https://example.com/US0000000000.ASSET01.XYZ) provided through the public web interface 103 containing real-time asset information, such as verification status, token count, and smart contract details obtained from the blockchain through the blockchain interface 102 (in some embodiments, the web server 104 is able to directly read the blockchain or in other embodiments it utilizes a third-party API to do so, e.g., the Etherscan API).

In step 235, the facilitator creates a smart contract is created on the blockchain (e.g., Ethereum) using the various appropriate asset parameters. The subdomain ID token (e.g., US0000000000.ASSET01.XYZ) is added to the blockchain name service 111 by sending the token information to a smart contract (which in some embodiments may be controlled by the facilitator) within the blockchain name service 111 which creates the token within the blockchain name services and then creates and sends a corresponding token to the smart contract 114 on the blockchain 110 and the token is thereafter embedded into the smart contract 114. (The blockchain name service 111 is, for example, a name-lookup smart contract that provides a domain-to-smartcontract lookup table, e.g., the Ethereum Name Service, a domain name service built on the Ethereum blockchain. Other similar systems exist in, for example, the XDC “XinFin Digital Contract” network.) The QR code's binary data is stored in connection with the smart contract on the blockchain, ensuring immutability and a tamper-resistant reference to the asset.

Utilizing a distributed blockchain enables the distributed recording of transactions across a decentralized ledger, ensuring transparency and immutability. The blockchain stores the history of asset-related transactions, token ownership, and certification records, making them accessible and verifiable by all parties involved. Utilizing a distributed blockchain also helps ensure that every transaction and ownership change is recorded on a decentralized ledger, providing a transparent, tamper-proof audit trail of all contract conditions and ownership histories. Decentralization eliminates single points of failure, significantly reducing the risk of unauthorized access or data manipulation. By storing ownership records across multiple nodes, the system ensures that transaction data remains secure, immutable, and accessible to all parties involved in the transaction. A distributed blockchain also enables real-time audits of ownership records, ensuring full transparency and promoting trust in the system.

The smart contract mints the appropriate number of tokens and makes them available for purchase through the smart contract. A token buyer 107 can purchase tokens for a specified price using native cryptocurrencies of the smart contract network or other supported cryptocurrencies (e.g., XDC, ETH, BTC, or stablecoins such as USDC or other bridged cryptocurrencies).

As tokens are purchased, the smart contract holds the funds until certification, discussed later, is completed. While the tokenizer is heavily involved in the process steps shown in FIG. 2, different entities may be involved. For example, one person or entity might submit asset parameters, and a second entity (or multiple entities) may submit documentation for verification.

In some embodiments, the smart contract may mint multiple different types of tokens, each token having certain rights or features with respect to the transaction. For example, some tokens may provide preferential asset income distributions. Some tokens may provide certain voting rights. Some tokens may provide only asset ownership with no rights to income distributions.

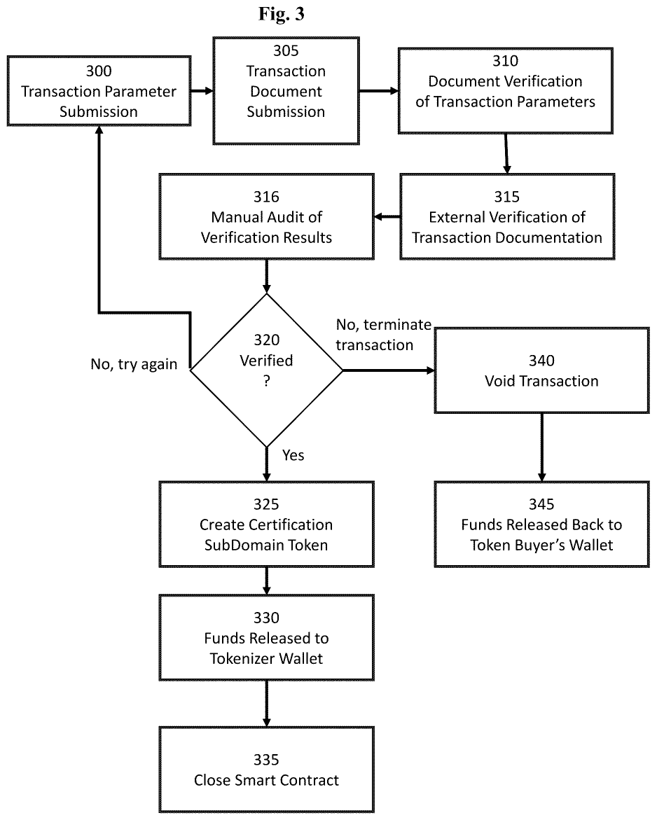

FIG. 3 depicts various steps involved in an exemplary tokenization process. In step 300, a certification process (e.g., a process to verify the transfer or sale of the tokenized asset) begins with the tokenizer 106 indicating to the facilitator that a sale of the tokenized asset has occurred or will occur via a web2 data collection interface (e.g., the client web interface 101) for storage in database 105. The tokenizer 106 also submits the transaction parameters (such as buyer/seller names, transaction amount, proposed closing dates, and other details) and identifies documents to be submitted. In step 305, the tokenizer 106 submits digital copies of the appropriate closing documents (e.g., final sale contract, buyer's and seller's ID, deeds, etc.).

In step 310, the facilitator's internal system performs document verification against the transaction parameters. The facilitator's document processing system 108 utilizes AI and OCR to scan and digitize the documents uploaded by the Tokenizer to the extent needed for that document type. NLP and NER are then employed by the document processing system 108 utilizes to identify and extract the relevant details. The document processing system 108 then cross-references the extracted data with the transaction parameters to verify correctness and consistency.

In step 315, extracted data is compared against external authoritative databases (such as chain of title records at a county property website) to verify the transaction. This can be done via AI agents utilized by the document processing system 108 to gather web data, or through manual verification performed by humans. In some embodiments, both AI agents and manual verification are used. In a preferred embodiment, there is a manual audit 316 of AI generated verification results.

In step 320, if the verification process fails but is found to be recoverable (e.g., in the case of incomplete or incorrect documentation), then the tokenizer is notified of discrepancies and is invited to edit or resubmit the transaction data and documentation whereafter the certification verification process is performed again. If the verification process is successful, then in step 325 the facilitator's internal system creates a certification domain-subdomain token (e.g., CERT_US0000000000.ASSET01.XYZ) and the token information is added to the blockchain name service 111 by sending the token information to a smart contract (in some embodiments, controlled by the facilitator) within the blockchain name service 111 which creates the token and sends the token to the smart contract 114 on the blockchain 110. In step 330, the receipt of the certification subdomain token triggers the smart contract 114 to release its stored funds to the tokenizer's wallet 112, completing the transaction. (This destination wallet could also be set to an arbitrarily appropriate wallet or wallets such as those for co-owners, agents, brokers, tax agencies, title companies, and so forth.) After releasing funds, the status of the transaction associated with the smart contract is set to “Certified” in the facilitator's internal system.

In step 335, after a successful completion of a sale, the smart contract becomes inactive after the asset is sold or transferred, helping to ensure that no further transactions can occur. After the sale is certified, the facilitator's internal system generates a web3 closing domain-subdomain token (e.g., CLOSE_US0000000000.ASSET01.XYZ). The closing subdomain token is sent to the smart contract 114 on the blockchain 110 via the blockchain name service 111 as discussed earlier with respect to other subdomain tokens. Upon receipt, the smart contract 114 enters an inactive state and becomes flagged as closed on the website linked to by the smart contract's QR code (and also in the facilitator's internal system). In one embodiment, if any funds are sent to the contract after closure, the smart contract automatically returns them to the sender, thus largely disabling further interactions with the smart contract post-closure.

In step 340, if the certification's verification process irrecoverably fails or the certification time limit (e.g., the certification time limit asset parameter) expires, one option is to void the smart contract and return funds to token buyers. In one embodiment, if certification is not completed within 30 days (or some other predefined timeframe), or otherwise irrecoverably fails, the facilitator's internal system generates a web3 voiding domain-subdomain token (e.g., VOID_US0000000000.ASSET01.XYZ). The voiding subdomain token is sent to the smart contract via the blockchain name service 111 as discussed earlier with respect to other subdomain tokens, canceling the transaction.

In step 345, upon receipt of the voiding subdomain token, the smart contract returns funds to the token buyer's wallet 113, and the tokens are recalled and/or burned. The facilitator's internal system updates the asset's status to “Voided” as would be reflected on the webpage linked to by the QR code and in the facilitator's internal system. This voiding process helps ensure that no incomplete or failed transactions remain active, protecting all parties involved.

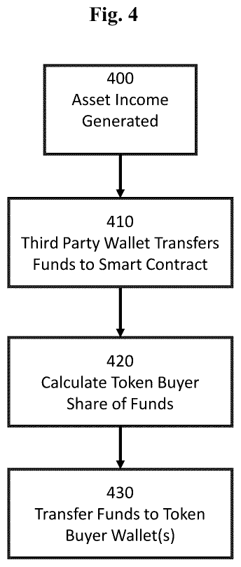

In some cases, an asset may generate ongoing income, for example, rental income or royalties. FIG. 4 depicts an income transfer process for tokenized assets. In step 400, income from the asset (e.g., monthly rental payments) is generated. In step 410, funds (e.g., cryptocurrency) are transferred from a third-party wallet (or wallets) 115 into the smart contract 114. This may happen, for example, through renters sending funds directly to the smart contract 114 or via an asset manager or other third-party receiving rental payments in a national currency and then transferring corresponding funds in the form of cryptocurrency to the smart contract 114 on the blockchain 110. In some embodiments, the smart contract is configured such that only a wallet having a KYC subdomain token (discussed with respect to FIG. 7) is permitted to send funds to the smart contract.

In step 420, the smart contract calculates each token buyer's revenue share based on, for example, the token buyer's ownership percentage of all of the smart contract's 114 tokens. In step 430, the smart contract 114 distributes the income to the respective token buyer 107 wallets 115. This process continues for each income event until the tokenization process is closed as discussed above. In some embodiments, the smart contract is configured such that only a wallet having a KYC subdomain token (discussed with respect to FIG. 7) is permitted to receive funds from the smart contract.

In some embodiments, funds received by the smart contract (that are not for the purchase of minted tokens) are added to the funds to be distributed to the tokenizer upon certification. In some embodiments, the funds are distributed to the token buyer(s) upon certification. The manner of calculating distributions may also vary based on the number of token buyers and the types of tokens minted by the smart contract.

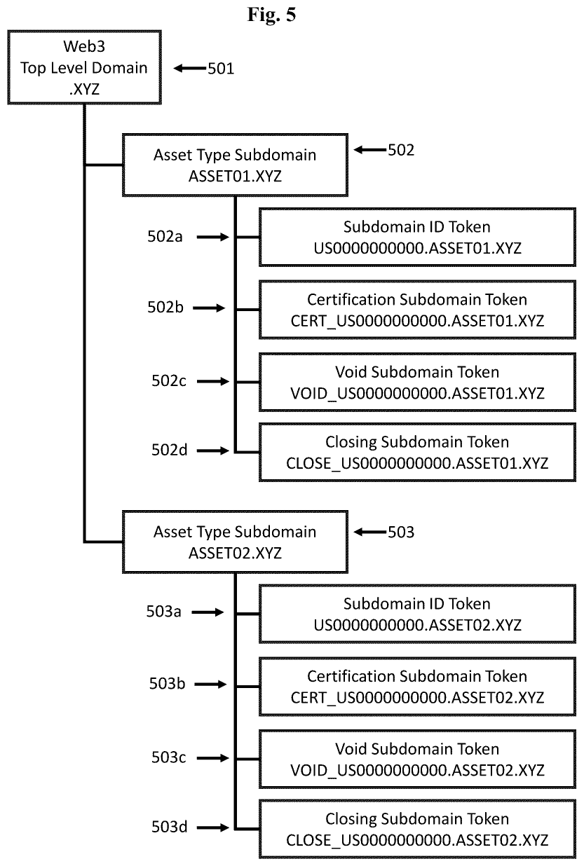

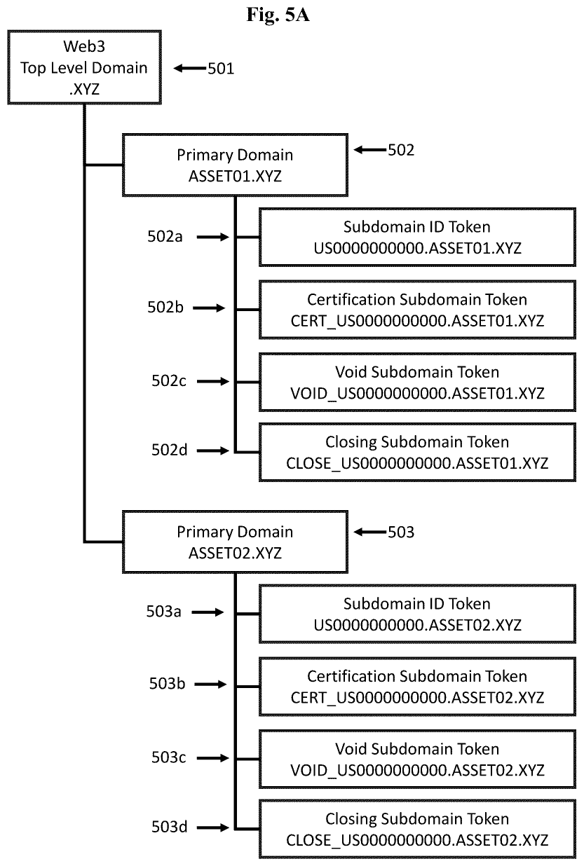

FIG. 5 depicts various embodiments of web3 domain-subdomain tokens. Note that in web2, the top-level domain is sometimes called the “domain extension” and the combination of the second-level domain and an extension comprise a “domain name” such as google.com or supremecourt.gov. In web2, the top-level domain is generally inaccessible, meaning that “com” or “gov” standing alone will not resolve to an IP address. With respect to web3 domains, the combination of the top level domain/extension and the second level domain is often called a “primary domain” and the second-level subdomain simply “the subdomain”. For example, in typical web3 nomenclature, with respect to US0000000000.ASSET01.XYZ, the ASSET01.XYZ label can be considered to be a “domain” or “primary domain” with the US0000000000 label acting as the subdomain. Note also ERC-137's definition of a domain and label:

<domain> ::= <label> | <domain> “.” <label>
<label> ::= any valid string label per [UTS46]

However, the use of the word “label” herein is in the more general sense. FIG. 5A provides alternative nomenclature with respect to FIG. 5 as discussed above. Various embodiments of Web3 domain-subdomain tokens include identifiers for physical assets (e.g., real estate) as well as digital assets (e.g., intellectual property) and identity (e.g., user1234.kyc.xdc).

In FIG. 5, the top or first level web3 domain is labeled XYZ (item 501). XYZ has various second level web3 subdomains, ASSET01 (item 502) and ASSET02 (item 503). These two web3 subdomains in this embodiment indicate an asset type, for example, ASSET01 corresponds to real estate, and ASSET02 corresponds to collectable coins. In some embodiments, the second level web3 subdomains could also have more specific labels with respect to the asset such as, such as AUTO or UNDEVELOPED_LAND.

Each of these (502, 503) second level web3 subdomains have additional web3 subdomains underneath them, each of them a third level web3 subdomain (e.g., US0000000000 and VOID_US0000000000). By utilizing a web3 domain and two web3 subdomains, a web3 domain-subdomain token may be defined (e.g., US0000000000.ASSET01.XYZ and VOID_US0000000000.ASSET02.XYZ). For example, a web3 domain-subdomain ID token (items 502a, 503a), a certification web3 domain-subdomain token (items 502b, 503b), a void web3 domain-subdomain token (items 502c, 503c), and a closing web3 domain-subdomain token (items 502d, 503d).

Each web3 domain-subdomain token resolves to a single smart contract associated with that specific token. Not all third level subdomains can exist at the same time, for example, in this embodiment, simultaneous associations of a void and close web3 domain-subdomains tokens are mutually exclusive. These web3 domains and subdomains are present in the blockchain name service 111 which associates each third level subdomain with a specific smart contract 114 address. Each smart contract 114 also has its own list of subdomain tokens associated with it.

In one embodiment, the various web3 domain-subdomain tokens are generated with a unique ID that guarantees both its security and immutability in the blockchain name service 111. This ensures that once the token is created and added to the blockchain name service, its correspondence to the designated smart contract address cannot be altered (assuming immutable blockchain name service records), providing a tamper-proof record of ownership and transaction details.

By knowing the name of the third level subdomain token, a user may utilize the blockchain name service 111 to find the corresponding smart contract 114. The blockchain name service 111 and/or the smart contract 114 may also be queried for the presence of a specific subdomain token (e.g., VOID_US0000000000.ASSET01.XYZ) and information about the lifecycle or state of the smart contract 114 inferred therefrom (e.g., a void subdomain token is present and therefore the smart contract and the transaction has been voided). Additionally, in some embodiments, funds may be sent to the smart contract using either the subdomain name (as opposed to the hexadecimal address of the smart contract), offering a user-friendly and human-readable option for income distribution.

While FIG. 5 depicts subdomain tokens as having a top level, a first level subdomain, and a second level subdomain, multiple levels of subdomains may be used. For example, US0000000000.MA.BOSTON.FENWAY.ASSET01.XDC might be used, where each of the US0000000000.MA.BOSTON.FENWAY subdomains are additional subdomains with geographic information utilized to indicate location information for a real-estate asset. And in some simplistic embodiments, only one subdomain may be utilized, e.g., US0000000000.XDC.

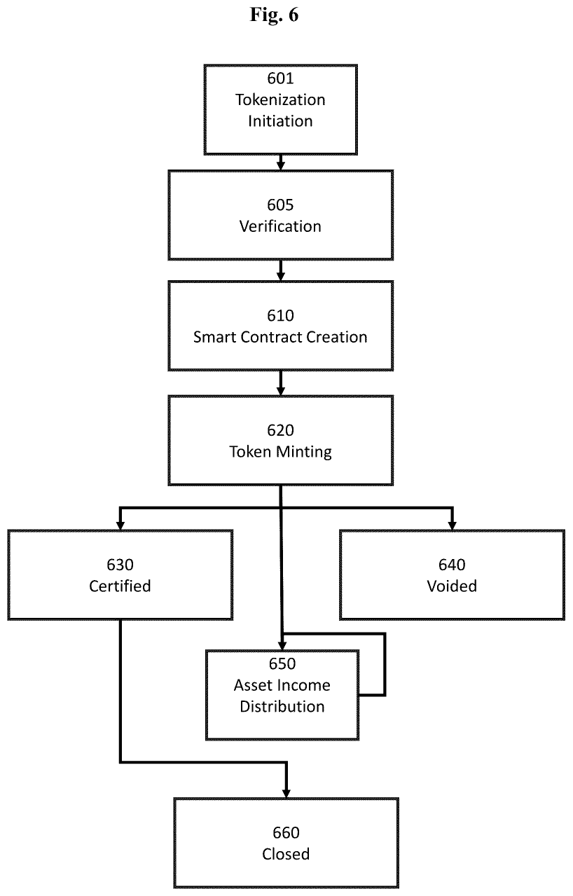

FIG. 6 depicts a high-level view of one embodiment of the tokenization process. At the Tokenization Initiation step 601, various aspects of the token and smart contract are initially defined. At the Verification step 605, the asset being tokenized is authenticated and the documents substantiating the asset parameters are verified against the asset parameters and external databases. At the Smart Contract Creation step 610, a smart contract corresponding to the asset is created and the subdomain ID token is associated with the smart contract. At the Token Minting step 620, the smart contract mints tokens and made available to token buyers. In some embodiments, token buyers are limited to those wallets that have a (generally or in some embodiments a specifically identified) KYC subdomain token associated therewith, ensuring that those who participate in the process are known to a service provider such as the tokenizer and/or other service providers like banks or cryptocurrency exchanges.

Next, an asset sale or transfer transaction is certified in step 630 (and a certification subdomain token is generated and associated with the smart contract) or voided in step 640 (and a void subdomain token is generated and associated with the smart contract which causes the smart contract to enter a void state). Income distribution step 650 happens repeatedly until the smart contract is closed in step 660. In some embodiments, income distribution is limited to those wallets having a (generally or in some embodiments a specifically identified) KYC subdomain token.

In some embodiments, token holders can resell their tokens on secondary markets, and the blockchain updates token ownership records accordingly. For example, token holders may list their tokens for resale on supported secondary markets or conduct peer-to-peer sales. Once the tokens are sold, in some embodiments, the smart contract updates ownership records to reflect the new token holders. Future income distributions or asset sale proceeds are then directed to the wallets of the new token holders, ensuring accurate record-keeping. This allows token holders to resell their ownership stakes while the blockchain maintains accurate ownership and income distribution records.

### Detailed Use Cases

Various embodiments of the present invention are useful in certification processes and have broad applicability, making it ideal for industries requiring secure, immutable transactions. Sectors such as real estate, finance, legal, supply chain, intellectual property, and digital rights management can benefit from the system's web3 subdomain token mechanisms and time-based voiding features.

The following example provides a step-by-step breakdown of the end-to-end process for tokenizing, verifying, certifying, and managing real-world assets (here, real estate) using a blockchain-based system. In this simplified example, a property owner wants to sell real estate to a set of one or more buyers via a tokenization process where the buyers will also be token owners/holders. A KYC process as discussed later with respect to FIG. 7 may also be incorporated into the example below.

Stage 1: Tokenization Initiation (Preliminary Data Staging). The process in a real estate tokenization and sale scenario starts with the Tokenizer (e.g., the property owner, but in other examples may be a party other than the property owner such as a property manager or a real estate agent) entering asset parameters into a web2 data collection interface (here the interface is controlled by the facilitator, a single company herein known as “TokenTEQ” which in this example mediates various steps in the asset tokenization process), including the asset type, value, and desired number and type of tokens to be issued.

In this example, the Tokenizer inputs one or more of the following asset parameters:
Asset Type: Real estate, vehicle, artwork, digital identity, intellectual property, or other tangible and intangible asset classes, here in this example, real estate.
Asset Value: $500,000 (e.g., for the property at issue).
First Type of Tokens: ownership tokens.
Second Type of Tokens: N/A.
Number of Tokens for First Type: 1,000 tokens are to be issued, each token representing 0.1% ownership of the asset.
Cost Per Token: Given an asset value of $500,000 and 1,000 tokens, each token is valued at $500. This will be the amount that buyers pay to purchase each token through the smart contract. (A price may also be specified in a stablecoin via bridging.)
Owner's Wallet Address: 0x1234A . . . C5678 (the wallet where funds will be sent post-certification).
Certification Time Limit: 30 days from initiation.
Identification of Property Owner
Identification of Property
Legal Documentation References: Property deed, vehicle title, artwork provenance, or other supporting documents. (This may include specifying the documents to be provided, and may also include an upload of the specified document in some embodiments.)

A unique asset ID (e.g., US0000000000.ASSET01) is created and stored in the TokenTEQ internal system database. This ID is used to track the asset through all subsequent processes and will later be used in the subdomain ID token. Here, ASSET01 represents the asset class of real estate and the US0000000000 represents a unique ID corresponding to the real estate to be tokenized.

The asset details are held in a preliminary staging environment in the TokenTEQ internal system's database. In some embodiments, no smart contract is created at this point so as to prevent premature contract creation and avoid potential resource wastage. This prevents the premature creation of smart contracts and avoids the risk of “zombie” contracts. This Stage 1 establishes the asset's identity in TokenTEQ's internal system, ensuring that necessary asset details are collected and verified before moving on to the smart contract creation stage.

Stage 2: Asset Verification (Authenticating Ownership and Asset Details). In this stage, the asset's ownership and legitimacy are verified by TokenTEQ's document processor system using a combination of AI-driven and/or manual processes to ensure that all information is accurate and up to date. The Tokenizer (or some other person or entity) submits digital copies of supporting documents (e.g., property deed, personal identification, property tax documents, etc.) through a secure, encrypted channel to TokenTEQ's document processor system.

The TokenTEQ document processor system then uses artificial intelligence (“AI”) and related technologies like Optical Character Recognition (OCR) to scan and digitize the documents uploaded by the Tokenizer. Natural Language Processing (NLP) and Named Entity Recognition (NER) are then employed to identify and extract key details such as the owner's name, asset location, serial numbers, and so forth.

Extracted data is then cross-referenced with the asset data provided by the Tokenizer, as well as external authoritative databases (such as chain of title records at a county property website) to verify authenticity and ownership. This can be done via the document processor system's AI agents gathering web data, or through manual verification performed by humans. In some embodiments, both AI agents and manual verification are used.

If the documents are successfully validated against the information the Tokenizer provided as well as the authoritative databases, then the TokenTEQ internal system updates the asset status to “Verified,” and a subdomain ID token (e.g., US0000000000.ASSET01.TEQ) is generated. If verification fails, the Tokenizer is notified of any discrepancies and given an opportunity to fix them and present the asset for verification again.

Upon verification success, the subdomain token is added to a name-lookup smart contract in a blockchain name service that enables a domain-to-smartcontract lookup table (similar to the Ethereum Name Service, a domain name service built on the Ethereum blockchain). In this example, TokenTEQ uses its own wallet keys as the authoritative source to update the domain-to-smartcontract lookup table on the blockchain. At this stage, successful verification establishes the authenticity of the asset and enables the TokenTEQ system to proceed with smart contract creation.

Stage 3: Smart Contract Creation and Token Issuance. Upon successful asset verification, the TokenTEQ system creates a smart contract on the selected blockchain network, for example the Ethereum blockchain, and the smart contract mints tokens representing fractional ownership of the asset. In particular, the TokenTEQ system generates a smart contract on the blockchain, embedding the subdomain ID token as a reference. The smart contract then mints, in this example, 1,000 tokens, each representing 0.1% ownership of the asset. These tokens are initially stored in the smart contract. The tokens are listed for purchase through the smart contract. Buyers can purchase tokens for a specified price using supported native cryptocurrencies of the smart contract network or other supported cryptocurrencies (e.g., XDC, ETH, BTC, or stablecoins such as USDC or other bridged cryptocurrencies).

As tokens are purchased, the smart contract holds the funds until certification (discussed with respect to Stage 5) is completed.

Stage 4: Binary QR Code Generation and Blockchain Storage. In some embodiments, a binary quick reference (“QR”) code is generated by the TokenTEQ internal system upon asset verification in stage 2 above, using 0's and 1's to represent black and white pixels in a pixel frame, creating a scannable black and white QR code. The QR code is linked via a uniform resource locator (“URL”) to a webpage that incorporates the subdomain ID (e.g., https://example.com/US0000000000.ASSET01.TEQ). The QR code's binary data is stored in connection with the smart contract on the blockchain, ensuring immutability and a tamper-resistant reference to the asset.

When scanned, the QR code directs users to a webpage (e.g., example.com/US0000000000.ASSET01.TEQ) containing real-time asset information, such as verification status, token count, and smart contract details obtained from the blockchain (in some embodiments, the server hosting the webpage is able to read the blockchain itself or utilizes a third-party API to do so).

Stage 5: Certification Process (Verifying Transaction and Ownership Transfer). In this stage, a certification process verifies the ownership transfer or sale of the actual real estate asset, confirming that the buyer(s) and seller have completed the transaction. The seller (the Tokenizer in this case, or in some circumstances the buyer or property manager or other appropriate party or parties) indicates to TokenTEQ that a sale of the tokenized real estate has occurred or will occur, submits the transaction meta data (such as buyer/seller names, transaction amount, proposed closing dates, and other details) and identifies documents to be submitted, and/or submits digital copies of the appropriate closing documents (e.g., final sale contract, buyer's and seller's ID, deeds, etc.) through the TokenTEQ web data collection interface. While the Tokenizer may specify the certification time limit in Stage 1, TokenTEQ itself may, in some embodiments, also specify a time-frame wherein the transaction must be completed.

Once the transaction meta data and documents have been provided, the document processor system uses AI and/or manual processes verify the closing documents against the internal data about the property and the metadata provided by the Tokenizer about transaction to ensure they match the verified asset details. Once the sale has been completed, TokenTEQ checks for any inconsistencies or errors and cross-references with authoritative external databases (e.g., government property records) to confirm ownership transfer. This may be done using AI web agents, via manual review, or both.

Upon successful verification of the sale or transfer, a certification subdomain token (e.g., CERT_US0000000000.ASSET01.TEQ) is generated and sent to the smart contract on the blockchain. The receipt of the certification subdomain token triggers the release of funds from the smart contract to the seller's wallet, completing the transaction.

Stage 6: Automatic Voiding Mechanism (Handling Failed or Incomplete Transactions). If the certification process in stage 5 fails or the certification time (e.g., the Certification Time Limit in stage 1) limit expires, the goal is to void the transaction and the smart contract and return funds to token buyers. In this example, if certification is not completed within 30 days (or some other predefined timeframe), or otherwise fails, the TokenTEQ internal system generates a Web3 voiding subdomain token (e.g., VOID_US0000000000.ASSET01.TEQ). The voiding subdomain token is sent to the smart contract, canceling the transaction, and putting the smart contract into a voided state.

Thereafter, upon receipt of the voiding subdomain token, the smart contract returns funds to the buyers, and the tokens are recalled and/or burned. The TokenTEQ internal system updates the token's transaction's status to “Voided” as would be reflected on the webpage linked to by the QR code. This voiding process helps ensure that no incomplete or failed transactions remain active, protecting all parties involved.

Stage 7: Closing Mechanism (Deactivating the Smart Contract Post-Sale). In this example, after the certification subdomain token is sent to the smart contract, and after transfer of ownership of the real estate by deed to the token holders, the token holders then choose to lease the real estate to tenants. The tenants pay their rent by sending funds to the smart contract each period of time (e.g., monthly). Those rental funds are then automatically distributed in proper proportion to each of the token holders' wallets via the smart contract.

After a period of time, the token holders wish to sell the real estate. The TokenTEQ system receives and certifies the new buyer's information and sale documents similar to Stage 5. Once certified, a closing token is created on the blockchain name service and thereafter a corresponding token is issued to the smart contract. This token modifies the smart contract to require token holders to send their tokens to the smart contract in order to get the sale proceeds and thereafter renders the smart contract inactive. After the successful completion of the sale (or transfer), the smart contract becomes inactive, helping to ensure that no further transactions can occur.

In greater detail, after the sale is certified, the TokenTEQ system generates a web3 closing subdomain token (e.g., CLOSE_US0000000000.ASSET01.TEQ) and registers it with the block chain name service (as with other subdomain tokens). The closing subdomain token is then sent to the smart contract on the blockchain. Thereafter, the smart contract becomes inactive and becomes flagged as inactive on the website linked to by the QR code.

Where the token buyer anticipates receiving funds from the smart contract, the closing subdomain token may change the smart contract income distribution from automatic to then requiring the buyer's token(s) to be sent back to the smart contract in order to redeem the token for the funds. In this way, funds sent to the smart contract after the closing token is received are held until redeemed by transfer of the buyer's token to the smart contract. In some scenarios, the new asset owner may opt to re-tokenize the asset, initiating a new tokenization process under a different subdomain, allowing for flexibility and reuse of the system.

### Other Applications

The system's adaptability allows it to be seamlessly integrated into existing digital infrastructures, providing a scalable solution for industries that handle high-value or sensitive transactions. It enhances the security of ownership verification, contract execution, and data integrity, making it a valuable tool for sectors that demand regulatory compliance and data protection, such as financial services and legal institutions.

Moreover, the system supports a wide range of assets and transaction types, allowing for the automation of rental income, royalties, or sale proceeds through smart contracts. The ability to send funds to the smart contract using either the subdomain name or the hexadecimal address adds significant flexibility and ease of use for participants across various industries. Additionally, the system facilitates the tokenization of digital identities and intellectual property, enabling secure, verified, and portable digital credentials for use across various platforms and applications.

For example, in the real estate sector, rental income from properties can be automatically routed to the smart contract via a user-friendly subdomain (e.g., rwa1234.REALESTATE.xyz).

Similarly, in the intellectual property sector, royalties from licensed assets can be managed securely and efficiently using this method. This adaptability makes the system highly useful for industries involved in leasing, licensing, or any revenue-generating assets, whether tangible or intangible. Similarly, in some embodiments, virtual-world assets (including but not limited to game skins, game characters, website or game accounts, virtual real estate, etc.) may also be tokenized.

The decentralized nature of the system, combined with its use of Distributed Ledger Technology (DLT) and blockchain, helps ensure that all transactions are secure, transparent, and tamper-proof. The system's features, including multi-factor authentication and encryption protocols, provide enhanced protection for ownership records, contract data, and financial transactions, making it an indispensable tool for industries focused on security and compliance.

With its flexibility, the system can be customized to meet the specific certification and transaction needs of various industries, making it a key solution for organizations looking to modernize their digital certification processes and automate the secure management of asset-generated income. Additional embodiments of the present invention are considered below.

### Real Estate Tokenization

The system can be adapted to handle the tokenization of real estate assets, enabling fractional ownership of properties through a secure and transparent process. Utilizing AI-driven document verification, the system ensures that property details, ownership records, and legal documents are accurately represented before the asset is tokenized. Ownership tokens are generated and linked to asset-specific subdomains (e.g., ADDRESS1234.REALESTATE.XYZ), creating a unique digital identifier for each tokenized property.

For real estate assets that generate ongoing income (e.g., rental income or lease payments), the smart contract automatically calculates and distributes revenue to token holders based on their ownership share. Income or sale proceeds are directed to the smart contract, and payouts can be made using the asset's subdomain name for user-friendly transactions. The system also supports the resale of tokens on secondary markets, with the smart contract updating ownership records in real-time, ensuring full transparency and traceability of property ownership.

### Vehicle Tokenization and Transfer

The system can be adapted to facilitate the secure tokenization and transfer of vehicle ownership, covering a wide range of assets such as cars, boats, and aircraft. Using verified documents (e.g., VINs for cars, hull numbers for boats, tail numbers for aircraft), the system conducts AI-driven verification to confirm the asset's identity and ownership. Once verified, a subdomain token is created (e.g., AUTO1234.VEHICLE.XYZ), serving as a unique, tamper-proof digital representation of the vehicle on the blockchain.

Ownership transfers are streamlined through the use of certification tokens, which automatically trigger the release of funds and update the ownership record on the blockchain. Compliance is ensured through a KYC verification process using Decentralized Identifiers (DIDs), linking verified user identities to the transaction. This approach provides a transparent, secure framework for vehicle ownership tracking, enabling efficient transfers while reducing the risk of fraud and enhancing regulatory compliance. The immutable blockchain records ensure that all parties can verify the vehicle's ownership history, offering a trusted, verifiable audit trail.

### Intellectual Property and Digital Rights Management

The system can be adapted to facilitate the tokenization of intellectual property (IP) assets, including patents, copyrights, and trademarks. Through a secure verification process, the system confirms the ownership and validity of the IP asset before creating a digital representation on the blockchain. Verified IP assets are linked to unique subdomains (e.g., CONTENT001.DIGITAL.XYZ), providing a traceable and tamper-proof identifier for each tokenized asset.

For IP assets that generate ongoing revenue (e.g., licensing fees or royalties), the smart contract automates the distribution of payments to IP holders. The smart contract tracks usage and income events, calculating the appropriate share for each token holder. Payments can be directed through the subdomain, simplifying financial transactions while ensuring transparency and accuracy. The system's immutable record-keeping provides IP holders with a clear, verifiable audit trail of income distribution, enhancing trust and efficiency in digital rights management.

### Digital Identity Verification and DID Services

The system supports robust digital identity verification using a Web3 KYC process combined with Decentralized Identifiers (DIDs). Users undergo a secure KYC process where their personal information and identification documents are verified through AI-driven analysis or third-party verification services. Upon successful verification, a unique DID is issued and linked to the user's identity subdomain (e.g., user1234.KYC.XYZ). This tokenized digital identity is securely stored on the blockchain, providing a verifiable and tamper-proof identity reference.

The verified identity can be utilized across multiple platforms, offering seamless cross-platform interoperability without the need for repeated KYC verification. By leveraging DIDs, the system ensures that users can securely interact with a variety of services, such as financial applications, digital asset platforms, and regulatory-compliant transactions. This approach enhances privacy, reduces onboarding friction, and strengthens compliance with regulatory requirements, while providing a consistent and trusted framework for identity verification in the digital ecosystem.

### Artwork and Collectibles Tokenization

The system can be adapted to facilitate the tokenization of high-value artwork and collectibles, applying AI-driven and/or manual verification processes to confirm ownership and provenance of assets such as paintings, sculptures, and rare collectibles. Once the verification process is complete, a unique subdomain token is issued (e.g., ART1234.FINEART.XYZ) and linked to the artwork's smart contract, creating a secure, tamper-proof digital record that captures ownership history, provenance, and any rental agreements directly on the blockchain.

For artworks that generate income (e.g., rental fees from museum exhibitions or proceeds from sales), the system automates the collection and distribution of payments to token holders. Funds are deposited into the smart contract and allocated based on each holder's fractional ownership share. Transactions are facilitated through the artwork's subdomain (e.g., art123.FINEART.XYZ), simplifying the process while ensuring full transparency in financial distributions. This approach provides a verifiable, immutable audit trail of both ownership and income events, significantly enhancing trust, liquidity, and the overall efficiency of investments in the art market.

### Equipment Leasing and Asset Management

The system can be adapted to manage the tokenization and leasing of specialized equipment, such as medical devices, industrial machinery, and heavy equipment. By verifying ownership and condition through AI-driven analysis, the system securely tokenizes the asset, linking it to a unique subdomain identifier (e.g., EQUIP1234.INDUSTRIAL.XYZ). This digital representation provides a tamper-proof record of the asset's details, facilitating transparent management and ownership tracking.

For equipment that generates leasing income, the smart contract automates the collection and distribution of payments to token holders based on their ownership percentage. Lease agreements are executed securely via smart contracts, reducing the risk of disputes and ensuring timely payments. The use of asset-specific subdomains simplifies income transactions and provides real-time updates on leasing activity, allowing stakeholders to monitor equipment utilization, income flow, and ownership changes with full transparency and traceability on the blockchain.

### Supply Chain and Inventory Tokenization

The system can be adapted to facilitate the tokenization and tracking of products throughout the supply chain. Using secure verification processes, each product is assigned a unique subdomain token (e.g., PRODUCT001.SUPPLYCHAIN.XYZ), linked to a Decentralized Identifier (DID) and verified metadata. This tokenization creates a digital representation of the product on the blockchain, providing a tamper-proof, traceable record of its lifecycle.

The system offers real-time transparency and visibility into product movement across the supply chain, with each transaction and status update recorded immutably on the blockchain. Scannable QR codes linked to the subdomain allow stakeholders to verify the product's authenticity and access detailed metadata instantly. This approach enhances trust and accountability by ensuring that all parties have access to a secure, verifiable audit trail, streamlining supply chain operations and reducing the risk of fraud or counterfeit products.

### Event Ticketing and Fundraising

The system can be adapted to facilitate the tokenization of event tickets and fundraising initiatives. Through a secure issuance process, the system creates digital tickets as unique, verifiable assets on the blockchain. Verified tickets are linked to distinct event subdomains (e.g., EVENT001.TICKETS.XYZ), providing a traceable, tamper-proof identifier for each tokenized ticket.

For events generating revenue (e.g., ticket sales, donations), the smart contract automates the distribution of funds to organizers and investors. The smart contract tracks ticket sales and revenue events, calculating the appropriate share for each stakeholder. Payments are directed through the event subdomain, simplifying financial transactions while ensuring transparency and accuracy. The system also supports ticket resale on secondary markets, with real-time updates to ownership records, preserving accuracy and traceability.

Additionally, QR codes linked to the subdomain offer secure access control, allowing efficient entry verification at the event. This approach enhances the ticketing process by preventing counterfeiting, streamlining transfers, and ensuring transparent revenue sharing, delivering a secure and seamless experience for organizers and attendees alike.

### Web3 Know Your Customer

In another embodiment, a web3 primary domain (e.g., KYC.XYZ) is designed for identity verification purposes. A facilitator may generate a unique subdomain for each client or user who passes know-your-customer (“KYC”) verification, creating a decentralized identifier (DID) that tokenizes the verified digital identity. This web3 KYC subdomain token may then become an asset that the facilitator may then manage, control, or update. This DID can be linked to the customer's wallet on a blockchain and used for cross-platform verification in asset transactions.

This KYC feature helps ensure client identity verification through a secure and compliant process before clients participate in transactions. Client identity may be verified either through internal AI-driven methods or by using a third-party verification service. Once verified, a subdomain token representing a KYC-verified wallet is created for each client. This token enhances security, data privacy, and cross-platform interoperability by establishing a reusable, blockchain-based verification standard for clients' digital identities. In some embodiments, the existence of a KYC subdomain token may be a requirement written into the smart contract before that smart contract will allow the wallet to participate in transactions involving tokenized real-world assets (“RWAs”).

FIG. 7 depicts various steps of an exemplary embodiment of a web3 KYC tokenization process integrated with exemplary embodiments in FIG. 1 and/or FIG. 2. This process may, for example, run in parallel with a tokenization process and run in parallel with asset verification. It may also stand alone as a KYC tokenization process without any related asset tokenization process.

In step 700, an individual to be verified enters their identity and other parameters into a tokenization facilitator's internal system via a secured web2 data collection interface (e.g., via a client web interface) for storage in a database. This may be similar to a registration form. Exemplary identification parameters may include but are not limited to:
Name
Date of Birth
Email
Phone number
Address
Wallet Details
First Type of ID
First ID Number
First ID Details
Second Type of ID
Second ID Number
Second ID Details
Bank Details
Family Details
Employment Details
Corporation Details (e.g., if the client is a corporation as opposed to an individual) At this time (or perhaps later after verification is successful) a unique KYC ID for the user (e.g., USER1234.KYC.XYZ) is also created and stored in the database and associated with the client. This ID is used to identify the user and is later used in connection with the KYC subdomain token.

In step 705, the user submits the appropriate identification and related documents (e.g., copies of passport, drivers license, social security or tax identification number, and so forth). In some embodiments, real time image and/or video may be acquired from the client.

In step 710, the facilitator's internal system performs document verification against the identity parameters. The facilitator's document processing system utilizes Artificial intelligence (“AI”) and related technologies like Optical Character Recognition (OCR) to scan and digitize the documents uploaded by the user to the extent needed for that document type. The facilitator's document processing system then uses Natural Language Processing (NLP) and Named Entity Recognition (NER) to identify and extract details such as the user's name, document type and identification numbers, tax identification or social security numbers, and so forth. Extracted data is then cross-referenced by a document processing system with the identification parameters provided by the user to verify correctness and consistency. In some cases, this may be performed manually.

In step 715, extracted data is compared against external authoritative databases (such as third-party credit agencies, government databases, etc.) to verify document authenticity and user details. This can be done via AI agents utilized by the document processing system to gather web data, or through manual verification performed by humans. In some embodiments, both AI agents and manual verification are used. In a preferred embodiment, there is an optional manual audit 716 of AI generated verification results.

In some embodiments, the user/client provides their own wallet address for verification. In such a case, the user may be asked to transfer a specified (typically small) amount of cryptocurrency to a specified address (and sometimes within a specified period of time) as part of the verification process to confirm that the user controls the wallet. In some embodiments, the facilitator will create a new wallet and provide the keys to the client, thus ensuring that the wallet is controlled by the client.

In step 720, if the verification process fails, then the user is notified of discrepancies and is provided options to edit or resubmit the identity parameters and/or documentation whereafter the verification process is performed again in whole or in part. If the verification process is successful, then in step 725 the facilitator's internal system updates the user's status in the facilitator's internal system. The KYC subdomain token information (e.g., USER1234.KYC.XYZ) is then added to the blockchain name service by sending the token information and the client's wallet information to a smart contract (in some embodiments, controlled by the facilitator) within the blockchain name service which creates the KYC subdomain token within the blockchain name service, associates the wallet address with the KYC subdomain token, and then (optionally) creates and sends a corresponding wallet-receivable KYC subdomain token, having the KYC subdomain token information therein, to the wallet address on the blockchain.

The information associated with the KYC subdomain token is stored securely and referenced by the tokenizer's system to confirm the client's identity across platform transactions. Thus in some embodiments, the KYC subdomain token provides a blockchain-based identity reference that ensures only verified users participate in smart contract transactions, enhancing platform security and regulatory compliance.

This KYC subdomain token may also, in some embodiments, be a requirement for a wallet to purchase, sell, or receive income from asset tokens, or interact with a smart contract generally. For example, a smart contract could have conditional instructions requiring that any wallet interacting with the smart contract have a KYC subdomain token associated therewith in order to send or receive funds to that smart contract or to provide data to that smart contract. Proposed transactions from wallets without a KYC subdomain token associated therewith would have their transactions reversed or rejected.

In step 730, in some embodiments, a binary quick reference (“QR”) code is generated by the facilitator's internal system upon identification verification. The QR code uses 0's and 1's (bits) to represent black and white pixels in a pixel frame, the bits create a scannable black and white QR code. The QR code is linked via a uniform resource locator (“URL”) to a web3 asset metadata reference page 731, created by facilitator and accessible through the public web interface which incorporates the KYC subdomain token (e.g., https://example.com/USER1234.KYC.XYZ). When scanned, the QR code directs users to a webpage (e.g., https://example.com/USER1234.KYC.XYZ) provided through a public web interface containing real-time identity information. The website may have a “KYC Verified” badge or icon thereon to indicate a verification status (which may be full, partial, or some defined class of verification).

That information may include those specific details provided by the user and wallet details obtained from the blockchain through a blockchain interface (in some embodiments, the web server is able to directly read the blockchain or in other embodiments it utilizes a third-party API to do so, e.g., the Etherscan API). This may enable third-parties to obtain and/or verify all or a portion of the client's identifying information.

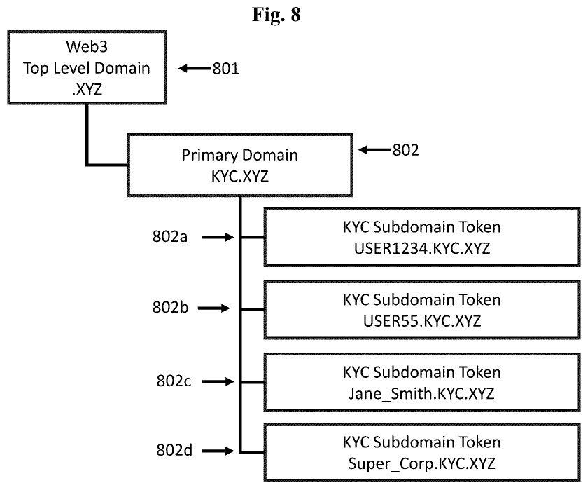

FIG. 8 depicts an exemplary embodiment of a web3 KYC subdomain token structure. In the depicted embodiment, the KYC subdomain token has the form of USER1234.KYC.XYZ 802a, where USER1234 is a client identifier, KYC is a subdomain and the label indicates the KYC nature of the subdomain token, and XYZ 801 is a top-level domain (sometimes referred to as a domain extension). In this example, a tokenizer controls the web3 primary domain “KYC.XYZ” 802 (which itself is also a token) and is able to issue KYC subdomain tokens (802a-802d) for “KYC.XYZ”. The tokenizer verifies through a KYC process its clients who want to engage in transactions on the blockchain. Once verified (e.g., through a process like FIG. 7) the tokenizer issues the KYC subdomain token for the client, e.g., USER1234. KYC.XYZ, and sends the KYC subdomain token to the wallet address on the blockchain. In some embodiments, the top level domain/extension may indicate the tokenizer or other service provider's identity e.g., USER1234.KYC.WORLDWIDEMEGABANK.

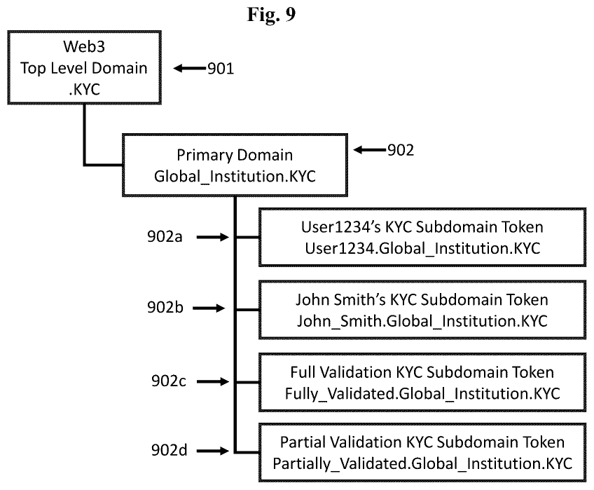

FIG. 9 depicts an exemplary embodiment of a web3 KYC subdomain token structure. In the depicted embodiment, the KYC subdomain token has the form of USER1234.GLOBAL_INSTITUTION.KYC 902a, where USER1234 is a client identifier, GLOBAL_INSTITUTION is subdomain and the label is a service provider identifier, and KYC 901 is a top-level domain indicating the KYC nature of the token. In this example, a bank controls the web3 primary domain “GLOBAL_INSTITUTION.KYC” 902 and is able to issue KYC subdomain tokens (902a-902d) for “GLOBAL_INSTITUTION.KYC”. The bank verifies through a KYC process its clients who want to engage in transactions on the blockchain. Once verified (e.g., through a process like FIG. 7) the bank issues the KYC subdomain token for the client, e.g., USER1234.GLOBAL_INSTITUTION.KYC, and sends the KYC subdomain token to the wallet address on the blockchain.

In some embodiments, the KYC subdomain token is unique to the client, e.g., USER1234.GLOBAL_INSTITUTION.KYC. In other embodiments, the KYC subdomain token may be generic or indicate a certain level of KYC process, e.g. FULLY_VALIDATED.GLOBAL_INSTITUTION.KYC or PARTIALLY_VALIDATED.GLOBAL_INSTITUTION.KYC.

While FIGS. 8 and 9 depict KYC subdomain tokens as having a top level, a first level subdomain, and a second level subdomain, multiple levels of subdomains may be used. For example, USER1234.US.NA.GLOBAL_INSTITUTION.KYC might be used, where each of the subdomains US.NA are additional subdomains utilized to give location information for a the client. And in some simplistic embodiments, only one subdomain may be utilized, e.g., USER1234.GLOBAL_INSTITUTION or USER1234.KYC.

This KYC subdomain token informs other blockchain users that the specific wallet address is associated with a person or entity whose identity is known by, and verified by, the bank. A corresponding QR code may also provide blockchain users with additional access to the client's identifying information in some cases. Smart contracts may be configured so as to only interact with wallets whose KYC subdomain token has been issued by a certain entity, or who have a specific subdomain token.

Although the invention has been described with respect to specific embodiments thereof, these embodiments, including those in an Appendix hereto, are merely illustrative, and not restrictive of the invention. Rather, the description is intended to describe illustrative embodiments, features and functions in order to provide a person of ordinary skill in the art context to understand the invention without limiting the invention to any particularly described embodiment, feature, or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes, and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, “in some embodiments”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

While one of the various inventions herein may be illustrated by using a particular embodiment, this is not and does not limit the invention to any particular embodiment and a person of ordinary skill in the art will recognize that additional embodiments are readily understandable and are a part of this invention.

### APPENDIX A

Appendix A hereto represents an additional set of exemplary embodiments. The embodiments described below include an advanced blockchain-based system for the secure management of digital certification and tokenization of real-world, digital, and/or identity assets. By integrating Web3 domain-subdomain tokens, Distributed Ledger Technology (DLT), Decentralized Identifiers (DIDs), and AI-driven verification processes, the system ensures immutability of smart contracts, protects client funds, and enhances transparency. This automated framework significantly improves the efficiency, security, and accuracy of managing diverse asset types across multiple industries.

### 1. Web3 Domain-Subdomain Token Structure

This system uses a hierarchical Web3 domain-subdomain structure to create unique, traceable identifiers for both assets and digital identities. This structure provides scalable and interoperable management of assets on the blockchain.

Examples like ASSET01.XYZ, KYC.XYZ, and US0000000000.ASSET01.XYZ are illustrative and flexible, allowing adaptation to various naming conventions based on specific needs.

### 2. Primary Domains and Subdomains

Asset Domain (ASSET01.XYZ):
   Verification Subdomain: US0000000000.ASSET01.XYZ represents an asset during the verification phase.
   Certification Subdomain: CERT_US0000000000.ASSET01.XYZ confirms certified ownership.
   Voiding Subdomain: VOID_US0000000000.ASSET01.XYZ indicates a voided transaction.
   Closing Subdomain: CLOSE_US0000000000.ASSET01.XYZ marks the end of the asset lifecycle.
Digital Asset Domain (DIGITAL.XYZ):
   Verification Subdomain: CONTENT001.DIGITAL.XYZ for digital assets like intellectual property under verification.
   Certification Subdomain: CERT_CONTENT001.DIGITAL.XYZ for certified digital assets.
KYC Domain (KYC.XYZ):
   KYC Subdomain: user1234.KYC.XYZ links a verified user's identity to their Decentralized Identifier (DID).
   Certification Subdomain: CERT_user1234.KYC.XYZ confirms the user's verified KYC status.
   Revocation Subdomain: VOID_user1234.KYC.XYZ indicates revocation of the KYC status.

### 3. Decentralized Identifiers (DIDs) for Identity Assets

The system leverages Decentralized Identifiers (DIDs) to represent verified user identities on the blockchain. DIDs provide a portable, verifiable identity that is interoperable across platforms.
DID Generation: Each verified user is issued a DID linked to their KYC subdomain (e.g., user1234.KYC.XYZ).
Interoperability: DIDs enable seamless, decentralized identity verification without repeated KYC processes.
Secure Storage: The DID and related metadata are stored immutably on the blockchain, ensuring privacy and security.

### 4. Subdomain Creation and Management

Primary Domain Establishment: The system establishes root domains like ASSET01.XYZ and KYC.XYZ for asset and identity management.
Dynamic Subdomain Generation: Subdomains are dynamically generated based on key lifecycle events (e.g., verification, certification).
Blockchain Storage: All subdomains and their associated metadata are stored immutably on the blockchain, ensuring a secure, verifiable record.

### 5. KYC Verification Process Using DIDs

The KYC process verifies user identities and issues a DID, creating a tokenized digital representation on the blockchain.

### KYC Steps:

1. User Registration: Users submit personal information and identification documents (e.g., passport, utility bill).
2. Identity Verification: The system employs AI-driven algorithms or third-party verification services.
3. DID and Subdomain Token Issuance: A DID and a KYC subdomain token (e.g., user1234.KYC.XYZ) are created upon successful verification.
4. Secure Storage: The DID and KYC token are stored immutably on the blockchain, ensuring secure identity management.

### 6. QR Code Integration for Verification

A binary QR code is generated upon verification, linking to a Web2 URL that references metadata stored on the blockchain. This hybrid approach leverages the accessibility of Web2 and the immutability of Web3.

### QR Code Features:

Links to a Web2 URL (e.g., example.com/US0000000000.ASSET01.XYZ or example.com/user1234.KYC.XYZ).
Webpage at URL displays icons representing the asset type or an identity badge.
Provides scannable access to detailed verification data and DID metadata.
Is stored immutably on the blockchain, ensuring a tamper-proof reference.

### 7. Tokenization Initiation Process

The tokenization process starts with preliminary data staging, where key asset details are collected before the smart contract is created.

### Initiation Steps:

1. Data Collection: The Tokenizer inputs asset details (e.g., asset type, price, number of tokens).
2. Asset ID Generation: A unique asset ID (e.g., US0000000000.ASSET01) is created.
3. Preliminary Staging: Data is stored until verification is complete to prevent premature smart contract creation.

### 8. Asset Verification Process

The system verifies asset authenticity and ownership through AI and manual checks.

### Verification Steps:

1. Document Submission: Ownership documents and proof of asset details are provided.
2. AI Analysis: The system uses OCR, NLP, and NER technologies for data extraction.
3. Cross-Reference Check: The extracted data is validated against authoritative external databases.
4. Token and QR Code Creation: A verification subdomain token (e.g., US0000000000.ASSET01.XYZ) and QR code are issued.

### 9. Certification Process

The certification process finalizes the verification, authorizing ownership or sale of the asset.

### Certification Steps:

1. Document Review: AI and manual checks verify the closing documents.
2. Certification Token Issuance: A certification subdomain token (e.g., CERT_US0000000000.ASSET01.XYZ) is created.
3. Fund Release: The certification token updates the smart contract, releasing funds.

### 10. Automated Voiding and Closing Mechanisms

The system includes automated mechanisms to handle failed or incomplete transactions.

### Voiding Steps:

1. Failure Detection: A voiding token (e.g., VOID_US0000000000.ASSET01.XYZ) is issued if certification fails.
2. Contract Cancellation: The voiding token cancels the smart contract and refunds buyers.

### Closing Steps:

1. Finalization: A closing token (e.g., CLOSE_US0000000000.ASSET01.XYZ) deactivates the smart contract after completion.

### 11. Income Distribution and Secondary Market Integration

Smart contracts facilitate automatic income sharing and token resale on secondary markets.

### Distribution Steps:

1. Income Deposit: Asset-generated income is deposited into the smart contract.
2. Revenue Calculation: The smart contract calculates each holder's share based on ownership.
3. Automatic Payouts: Income is distributed directly to token holders.

### 12. Applications and Use Cases

The system's versatility allows it to be applied across a broad range of industries and scenarios, leveraging tokenization, certification, and identity verification for both physical and digital assets. The following examples illustrate potential use cases, including but not limited to:

### 1. Real Estate Tokenization

Process: Fractional ownership of real estate properties is enabled by verifying, tokenizing, and certifying the assets using AI-driven document analysis. Ownership tokens are linked to asset subdomains (e.g., ADDRESS1234.REALESTATE.XYZ).
Features: Automated income distribution (e.g., rental income) and support for token resale on secondary markets, with updated ownership records maintained by smart contracts.

### 2. Vehicle Tokenization and Transfer

Process: Secure ownership tracking and transfer of vehicles (e.g., cars, boats, aircraft) using verified documents (e.g., VINs, hull numbers). Subdomain tokens (e.g., AUTO1234.VEHICLE.XYZ) are issued for verified assets.
Features: Automated ownership transfer triggered by certification tokens, and compliance verification through KYC processes using Decentralized Identifiers (DIDs).

### 3. Intellectual Property and Digital Rights Management

Process: Tokenization of intellectual property (IP) assets such as patents, copyrights, and trademarks. Verified digital assets are linked to subdomains (e.g., CONTENT001.DIGITAL.XYZ).
Features: Automated royalty payments through smart contracts, ensuring transparent and accurate distribution of income to IP holders.

### 4. Digital Identity Verification and DID Services

Process: Users undergo a KYC process that issues a DID linked to their identity subdomain (e.g., user1234.KYC.XYZ). Verified identities are securely stored and referenced on the blockchain.
Features: Cross-platform interoperability for verified identities, allowing users to interact with multiple services without repeated KYC verification, enhancing regulatory compliance.

### 5. Artwork and Collectibles Tokenization

Process: High-value artworks and collectibles are verified for provenance and ownership using AI technologies. Tokens linked to subdomains (e.g., ART123.FINEART.XYZ) represent fractional ownership.
Features: Support for fractional ownership, seamless secondary market trading, and automated distribution of income from rentals (e.g., museum loans).

### 6. Equipment Leasing and Asset Management

Process: Specialized equipment (e.g., medical devices, industrial machinery) is verified and tokenized with subdomain identifiers (e.g., EQUIP1234.INDUSTRIAL.XYZ).
Features: Automated lease payment distribution to token holders based on ownership shares, and secure execution of leasing agreements via smart contracts.

### 7. Supply Chain and Inventory Tokenization

Process: Products are tracked and verified throughout the supply chain using unique subdomain tokens (e.g., PRODUCT001.SUPPLYCHAIN.XYZ), linked to their DIDs and verified metadata.
Features: Real-time transparency and visibility of product movement, with authenticity verified through scannable QR codes linked to subdomains.

### 8. Event Ticketing and Fundraising

Process: Tickets for events are issued as tokens linked to event subdomains (e.g., EVENT001.TICKETS.XYZ), creating unique digital assets verified on the blockchain.
Features: Automated revenue sharing to organizers and investors, support for ticket resale while maintaining accurate ownership records, and secure access control via QR codes.

These embodiments outline a robust, scalable framework for the digital certification and tokenization of real-world, digital, and identity assets. By integrating Web3 domain-subdomain tokens, DIDs, AI-driven verification, and automated smart contracts, the invention offers a transparent, efficient solution tailored to the needs of modern asset management across multiple industries.

What is claimed is:

1. A method for tokenizing and managing assets using blockchain technology, comprising:
causing a domain-subdomain token to be created, the token having a top level domain identifier, and one or more subdomain identifiers under the top level domain, at least one of the sub-domain identifiers associated with an asset;
causing a smart contract to be generated on a blockchain in relation to the asset, wherein the smart contract references the domain-subdomain token.

2. A method for tokenizing and managing real-world assets using blockchain technology, comprising:
initiating a tokenization process for an asset by staging asset parameters in a database before generating a smart contract on a distributed blockchain, the smart contract being associated with the asset;
verifying the asset's ownership and existence by comparing the asset parameters against information obtained from one or more digital documents;
causing a domain-subdomain token to be created after successful verification of the asset's ownership and existence, the token having a top level domain identifier, and one or more subdomain identifiers under the top level domain, at least one of the sub-domain identifiers associated with an asset; and
causing to be generated a smart contract corresponding to the asset, wherein the smart contract references the domain-subdomain token.

3. A method for tokenizing a know-your-customer (“KYC”) process on a blockchain, comprising:
generating KYC subdomain token information, the token information having a top level domain identifier, and one or more subdomain identifiers under the top level domain identifier, at least one of the subdomain identifiers corresponding to a specific person or entity;
causing the KYC subdomain token information and wallet information to be sent to a blockchain name service whereafter the blockchain name service generates a KYC subdomain token comprising the KYC subdomain token information and the wallet information.

4. The process of claim 1, wherein the domain-subdomain token comprises exactly one subdomain identifiers.

5. The process of claim 1, wherein the domain-subdomain token comprises exactly two subdomain identifiers.

6. The method of claim 1, further comprising:
using the domain-subdomain token in a blockchain name service query to obtain an address for a smart contract associated with the asset.

7. The process of claim 1, further comprising:
creating underlying data for a quick response (QR) code, the data having a uniform resource locator (URL), and the URL having the domain-subdomain token therein;
providing access to a webpage corresponding to the URL of the QR code.

8. The process of claim 1, wherein the smart contract comprises an income distribution schedule in the smart contract, wherein funds are automatically distributed by the smart contract to token holders based at least in part on ownership percentage.

9. The process of claim 2, further comprising:
creating underlying data for a quick response (QR) code, the data having a uniform resource locator (URL), and the URL having the domain-subdomain token therein;
providing access to a webpage corresponding to the URL of the QR code.

10. The process of claim 2 wherein said smart contract is immutable and wherein the smart contract makes available asset tokens representing fractional or full ownership of the asset.

11. The process of claim 2, further comprising:
receiving closing or ownership documents for certification;
generating a certification domain-subdomain token; and
sending the certification domain-subdomain token to the smart contract, wherein thereafter the smart contract releases funds to a wallet address.

12. The process of claim 2, further comprising:
generating a closing domain-subdomain token after the sale or transfer of the asset;
sending the closing domain-subdomain token to the smart contract, wherein thereafter the smart contract releases funds to a wallet address upon receipt of a token from that wallet address.

13. The process of claim 2, further comprising:
receiving closing or ownership documents for certification;
generating a voiding domain-subdomain token; and
sending the voiding domain-subdomain token to the smart contract, wherein thereafter further transactions with the smart contract are prevented.

14. The process of claim 2 wherein the smart contract will become invalidated if a certification domain-subdomain token is not received by the smart contract within a predefined period of time.

15. The process of claim 2, wherein at least a portion of said information obtained from one or more of the digital documents was obtained using optical character recognition and named entity recognition.

16. The process of claim 2 wherein the smart contract comprises a payment escrow so that the smart contract holds funds until receipt of a second domain-subdomain token.

17. The process of claim 3, further comprising:
creating underlying data for a quick response (QR) code, the data having a uniform resource locator (URL), and the URL having the KYC subdomain token therein;
providing access to a webpage corresponding to the URL of the QR code.

18. The process of claim 3, further comprising:
generating a smart contract on a blockchain, the smart contract configured to interact only with a blockchain wallet associated with a KYC subdomain token.

19. The process of claim 3, further comprising:
causing a smart contract associated with the block chain name service to send a token comprising at least a portion of the KYC subdomain token information to the wallet address.

20. The process of claim 3, further comprising:
causing to be updated in the block chain name service the wallet address associated with the KYC subdomain token to a different wallet address.
